(19) United States
(12) Patent Application Publication
(10) Pub. No.: US 2026/0245213 A1
(43) Pub. Date: Aug. 20, 2026

(54) SYSTEM AND METHOD FOR SEMI-AUTOMATIC IMAGE SEGMENTATION BY USER INTERACTION LOOP LEARNING AND TRAINING METHOD THEREOF

(71) Applicants: SURGAR, CLERMONT-FERRAND (FR); UNIVERSITÉ CLERMONT-AUVERGNE, CLERMONT-FERRAND (FR); CENTRE NATIONAL DE LA RECHERCHE SCIENTIFIQUE, Paris (FR); CLERMONT AUVERGNE INP, Aubière (FR)

(72) Inventors: Adrien BARTOLI, Clermont-Ferrand (FR); Ivan MIKHAILOV, Clermont-Ferrand (FR)

(73) Assignees: SURGAR, CLERMONT-FERRAND (FR); UNIVERSITÉ CLERMONT AUVERGNE, CLERMONT-FERRAND (FR); CENTRE NATIONAL DE LA RECHERCHE SCIENTIFIQUE, Paris (FR); CLERMONT AUVERGNE INP, Aubière (FR)

(21) Appl. No.: 18/842,371

(22) PCT Filed: Feb. 28, 2023
(86) PCT No.: PCT/EP2023/055035

§ 371 Date: Aug. 28, 2024

(30) Foreign Application Priority Data
Feb. 28, 2022 (FR) FR2201763

(51) Int. Cl. G06T 7/10; G06V 10/82; G06V 10/94

(52) U.S. Cl. CPC G06T 7/10; G06V 10/82; G06V 10/945; G06T 2207/20084

(57) ABSTRACT

The invention relates to a semi-automatic image segmentation system comprising a neural network (12) configured to receive, at each iteration, input data comprising at least one image (14) to be segmented and to provide output data comprising at least one segmentation mask (16) of each image, characterized in that it further comprises a user interaction loop (18) comprising a user interaction module (20) configured to provide at least one user mask representative of an interaction of a real user and/or of a simulated user on each segmentation mask, said user interaction loop (18) being configured to provide, as input data of the neural network (12), each segmentation mask provided by said neural network coming from a previous iteration of the neural network (12), referred to as past segmentation mask, and the user mask associated with each past segmentation mask.

### TECHNICAL FIELD OF THE INVENTION

The invention relates to a system for 2D or 3D image segmentation comprising a neural network, a method of image segmentation using this system and a method of training the segmentation system, in particular the neural network thereof. The invention is intended in particular for the segmentation of medical images, for example from magnetic resonance imaging (MRI) or computed tomography (CT) for the identification of organs in each of the cut images obtained by MRI or CT in order to recreate 3D modeling of the organ from these segmentations.

### TECHNOLOGICAL BACKGROUND

The segmentation of images is a technique making it possible to associate with each pixel or voxel of a 2D or 3D image a label representative of the object, of the texture or of the state, etc. corresponding to said pixel or voxel.

Image segmentation is used particularly in a medical context to determine the organs, tissues, fluids, etc. visible in a 2D or 3D image. Such an image is, for example, obtained by MRI and makes it possible to form a 3D model of the targeted organ and, for example, of its environment and of the tumor to be operated on. This creation of a 3D model necessitates the segmentation of the images obtained by MRI.

Current segmentation techniques fall into a number of categories: manual segmentations, semi-automatic (also called interactive) segmentations or entirely automatic segmentations.

The manual approach is time-consuming, each pixel or voxel having to be categorized one by one by a user, and can thus require a number of hours for a single cut.

The automatic approach makes possible segmentation without user intervention but the lack of control can have a negative effect on the result and thus on application in practice. Furthermore, the result is never perfect and in order to obtain a better result the human operator must be able to maintain some control for validation reasons, and thus be able to correct errors.

The semi-automatic method makes possible interactivity in which the segmentation is both largely automatic but with a degree of control by a user, who can in particular act upon the initialization and upon a modification during certain steps.

The different segmentation procedures can implement methods based on deep learning, in particular using artificial neural networks. Deep learning is used in particular for the fully automatic methods, but the semi-automatic segmentation solutions using deep learning have received limited attention compared with the number of automatic solutions. Neural networks have made it possible to greatly improve the performance of the automatic segmentation solutions, but the semi-automatic segmentations have not benefited from such improvements owing to difficulties in achieving neural network integration.

In particular, the use of neural networks in semi-automatic segmentation poses problems in taking into account the interactions of the user during the training of the neural network. Taking the interactions of the user into account in this way causes problems in training of the system because the training data which take into account the user interactions must be adapted to the output of the neural network to which the interactions are applied, the neural network not being trained at the start of the process. This leads to a problematic dependency, the input data necessary to the training being themselves dependent on the output data to which the user interactions have been applied.

The solutions proposed to address these problems do not provide the desired levels of performance, in particular because the user interactions are not generally taken into account in a dynamic manner and have little impact on the quality of training because they focus on the input data. The solutions proposed generally approach the training of a neural network for semi-automatic segmentation tasks in the same way as for automatic segmentation. They generate user interaction masks from the annotated data, in a static manner before the training or in a dynamic manner during the training. The static generation methods form structures for input to the neural network which are the closest to automatic segmentation, and do not take into account the dynamic nature of the user interactions. The existing dynamic generation methods make it possible to diversify the training data and to increase performance but do not directly address the problematic dependency between the outputs and inputs of the system taking the interactions into account. In particular, the user interactions used in the dynamic processing do not reproduce a typical user interaction sequence because they do not take into account the order of these interactions.

The inventors have thus sought to improve the semi-automatic segmentation solutions in order to make it possible to better take into account the user interactions, in particular to take into account during the training the impact of the user interactions when the solution is being implemented.

### AIMS OF THE INVENTION

The invention aims to provide a system and method of semi-automatic image segmentation, in particular for medical type images, for example cuts obtained by MRI.

The invention also aims to provide a method of training such a segmentation system.

The invention aims to provide, in at least one embodiment, a semi-automatic segmentation system able to be trained easily by simulating user interactions.

The invention aims to provide, in at least one embodiment, a segmentation system, the operation and training of which make it possible to take earlier segmentation results into account.

The invention aims to provide, in at least one embodiment, a segmentation system, the operation and training of which make it possible to take earlier user interactions into account.

### DESCRIPTION OF THE INVENTION

In order to do this, the invention relates to a semi-automatic image segmentation system comprising a neural network configured to receive, at each iteration, input data comprising at least one image to be segmented and to provide output data comprising at least one segmentation mask of each image,
characterized in that it further comprises a user interaction loop comprising a user interaction module configured to provide at least one user mask representative of an interaction of a real user and/or of a simulated user on each segmentation mask, said user interaction loop being configured to provide as input data of the neural network:
each segmentation mask provided by said neural network coming from a previous iteration of the neural network, referred to as past segmentation mask, and
the user mask associated with each past segmentation mask.

An image segmentation system in accordance with the invention thus makes it possible to take into account the user interactions at the same time during the training and use for the image segmentation, and to associate these user interactions with a segmentation mask obtained at the output of the neural network as a new input of the neural network.

In particular, the training data are not obtained only by the recovery of a large data set but are generated by the segmentation system itself by virtue of the user interaction loop. The user mask is adapted according to the output data of the network and thus cannot be prepared in advance. Without this loop, as in the automatic segmentation systems, the system would only be trained from the images to be segmented and thus could not, in use, take the user interactions into account. Using only one input data set without the loop would thus not make it possible to obtain a satisfactory result, irrespective of the volume of this input data set. In particular using only one input data set without the loop would make it possible to obtain a system which does not make possible the modification of the result obtained, such modification being necessary in many fields, in particular in the medical field where a user must validate or edit the result before it is used in a therapeutic action.

Furthermore, the use of the output segmentation mask as an input makes it possible to introduce a sequentiality in the processing of the data in taking into account the past segmentation masks in the definition of a better future segmentation. The use of the output segmentation mask and of the user interaction as input data makes it possible to constitute an internal sequential memory which makes it possible to retain a trace of the past segmentations and user interactions in order to maintain the sequentiality of the system. In particular, the internal sequential memory retains all the user interactions and the previous segmentation masks obtained at the output of the neural network, in order to provide them as a new input of the neural network. The segmentation is otherwise accelerated because the sequential user interactions have more impact on the result.

The user interaction loop is used during the training of the neural network, during the test of the segmentation system from test data and also during the use of the segmentation system for new data.

Interaction by a real user is understood to be an interaction by a human user who interacts directly with the segmentation mask offered at the output. Interaction by a simulated user is understood to be the simulation of an interaction as a human user would be able to do, defined by a user interaction simulation algorithm. The user interaction is, for example, the assignment of a particular label to a precise point in the segmented image.

The user interaction makes it possible in particular to make a correction to the segmentation mask obtained at the output of the neural network, for example in indicating zones of the 2D or 3D image which have not been labeled correctly. Taking into account the user from the time of the training of the system makes it possible to improve the impact of the user corrections when the system is being used. Advantageously and by virtue of its training method, the image segmentation system can itself effect the initial segmentation when it is trained and takes into account the user corrections for an improvement in the segmentation. The initial segmentation can be trivial, in particular of little or no informative value, or calculated by another segmentation method, typically an entirely automatic method.

The system can advantageously be used for the segmentation of MRI images but can be applied to other types of 2D or 3D images, which may or may not be of the medical type. The system can be integrated in a larger system using the results of the segmentation for a particular application, for example for creation of a 3D model from segmented data and display of the 3D model in augmented reality in a video.

The neural network can be of a different type, the segmentation system not depending on a particular neural network in order to be used. In fact, the image segmentation system is characterized in particular by the user interaction loop which is external to the neural network. The neural network can integrate modules of the recurrent neural network, or RNN, type.

A module can consist, for example, of a computing device such as a computer, a group of computing devices, an electronic component or a group of electronic components, or, for example, a computer program, a group of computer programs, a library of a computer program or a function of a computer program executed by a computing device such as a computer, a group of computing devices, an electronic component or a group of electronic components.

Advantageously and in accordance with the invention, each user mask representative of a simulated user comprises a simulation of at least one interaction effected by the simulated operator on the segmentation mask associated with the user mask, the position of said interaction on the image being determined according to the difference between said output segmentation mask and ground truth.

According to this aspect of the invention, the position of the simulated interaction is determined in order to come close to what a real user would do, i.e. positioning his/her interaction in a zone which has been badly segmented or labeled, or in a zone which has no label.

Advantageously and in accordance with the invention, the position of the interaction is determined according to the center of a region selected as needing to be corrected by the user interaction.

Advantageously and in accordance with the invention, the system comprises a graph cut module configured to apply a graph cut to the output data of the neural network in order to obtain each segmentation mask.

According to this aspect of the invention, this step makes it possible to smooth the output data by using a graph cut algorithm to improve the relevance of the labels integrated in the segmentation mask. The graph cut algorithm is applicable for binary segmentation and derived algorithms are used for multi-class segmentations.

Advantageously and in accordance with the invention, the user interaction loop comprises an internal sequential memory in which each past segmentation mask and each user mask obtained at each iteration are stored sequentially.

Advantageously and in accordance with this latter aspect of the invention, the internal sequential memory comprises a first-in-first-out, or FIFO, type file, the file storing, at each iteration, the segmentation mask and the user mask corresponding to the iteration.

The invention also relates to a method of training an image segmentation system in accordance with the invention, using at least one data set comprising images to be segmented, characterized in that it comprises for each image of the data set:
at least two iterations in which the neural network processes the input data in order to provide output data, a first iteration in which the input data comprise at least one image to be segmented and a predefined initialization mask, and subsequent iterations in which the input data comprise each image to be segmented, each past segmentation mask obtained at the previous iteration, and a user mask representative of an interaction of a real user and/or of a simulated user,
a step of updating the weights of the neural network from the output data after each iteration or when a predetermined number of iterations have been effected by the neural network.

A training method in accordance with the invention makes it possible to simulate the user interactions in order to maximize the efficacy of the training and the relevance of the neural network resulting from the training. In contrast to the conventional models of the prior art in which updating of the weights is effected after each iteration, the training method in accordance with the invention advantageously uses the user interaction loop of the system in order to make possible the use of a user interaction simulation and of the output data, i.e. the segmentation mask of a previous iteration, as input data of the system. Thus the image segmentation system makes it possible to improve the user interaction simulation on the basis of the quality controls of the segmentation obtained, and to take into account the past segmentation masks and user interactions. The training thus makes it possible to reduce the number of false positives and of false negatives in simulating what a user would do when checking the quality of the segmentation.

The training sequence formed following iteration makes it possible to improve the precision of the corrections and thus to increase the quality of the segmentation at each iteration.

The updating of the weights is, for example, implemented by a loss function minimization algorithm, the gradient of which is, for example, calculated by back-propagation. The updating of the weights can be implemented at each iteration, in particular each time the output data are produced by the neural network, or only at the end of all the iterations so that the updating of the weights is effected only from the best segmentation obtained.

The initialization mask is for example a trivial mask, an empty mask, a mask obtained by automatic pre-segmentation or a mask derived from the ground truth, for example in simulating user interactions from this ground truth.

During the following iterations the initialization mask is added to the user mask which indicates the errors between the segmentation mask obtained at the output of the neural network and the result desired by the user.

Each data set can comprise one or more images, which may or may not be different. Even if two data sets comprise the same images, the training method will process two identical images differently by virtue of the simulated user interactions which make possible modifications in the training.

The simulated user interactions are obtained from ground truth. The ground truth is formed by predefined labeled data from which the error between the segmentation mask obtained at the output of the neural network and the desired result is determined. The training is thus supervised by virtue of previously segmented data, for which the regions of the image have labels which are allocated to them.

In the segmentation methods of the prior art, the training is generally effected only from these labeled data which do not suffice since the user and the segmentation masks of the previous iteration are not taken into account in the training. Furthermore, the training method in accordance with the invention makes it possible to provide different simulated user interactions for the same image, as would be the case with a real user who will never provide the same interactions for the same image.

Advantageously and in accordance with the invention, the predetermined number of iterations is determined for each image to be segmented and for each data set independently of the predetermined number of iterations determined for the other images to be segmented and the other data sets.

According to this aspect of the invention, the number of iterations is predetermined during the processing of a data set or of an image to be segmented but can be modified over time in order to reproduce the behavior of a real user who will not systematically effect the same number of corrections. A maximum number of iterations can be fixed in order to avoid the training being too long. Fixing the maximum number of iterations also makes it possible to avoid rendering the network dependent upon the interactions during the test phase. Since the interactions are based on the ground truth, it is preferable to aim for a minimum of interactions to be provided during the training phase while maximizing the performance so that a minimum of interactions are necessary during the test phase thereafter.

The invention also relates to a semi-automatic image segmentation method comprising, at each iteration, a step of processing input data comprising each image to be segmented by a neural network in order to provide output data comprising at least one segmentation mask of each image,
characterized in that each iteration further comprises:
a step of receiving a user mask representative of an interaction of a real user on each segmentation mask,
a step of transmitting, as input data of the neural network at the following iteration, each segmentation mask provided by said neural network, and the user mask.

According to this aspect of the invention, the image segmentation method makes it possible to take into account the interactions of the user as many times as necessary until the user considers that the quality of the segmentation of the image matches his expectations. If the quality is not sufficient, the interactions of the user and the segmentation mask are transmitted as input data in order to provide a new segmentation mask.

Advantageously, the image segmentation system in accordance with the invention is configured to implement the image segmentation method in accordance with the invention.

Advantageously, the image segmentation method in accordance with the invention is implemented by an image segmentation system in accordance with the invention.

The invention also relates to a computer program product for training an image segmentation system in accordance with the invention, said computer program product comprising program code instructions for executing, when said computer program product is executed on a computer, the steps of the training method in accordance with the invention.

The invention also relates to a computer program product for semi-automatic image segmentation, said computer program product comprising program code instructions for executing, when said computer program product is executed on a computer, the steps of the image segmentation method in accordance with the invention.

The invention also relates to an automatic segmentation system, an automatic segmentation method, an automatic segmentation computer program product, a training method and a training computer program product which are characterized in combination by all or some of the features mentioned above or below.

### LIST OF FIGURES

Other aims, features and advantages of the invention will become apparent upon reading the following description given solely in a non-limiting way and which makes reference to the attached figures in which:

FIG. 1 is a schematic view of a semi-automatic image segmentation system in accordance with one embodiment of the invention.

FIG. 2 is a schematic view of a semi-automatic image segmentation method in accordance with one embodiment of the invention.

FIG. 3 is a schematic representation of the steps of a method of training a semi-automatic image segmentation system in accordance with one embodiment of the invention.

### DETAILED DESCRIPTION OF AN EMBODIMENT OF THE INVENTION

In the figures, for the purposes of illustration and clarity, scales and proportions have not been strictly respected.

Furthermore, identical, similar or analogous elements are designated by the same reference signs in all the figures.

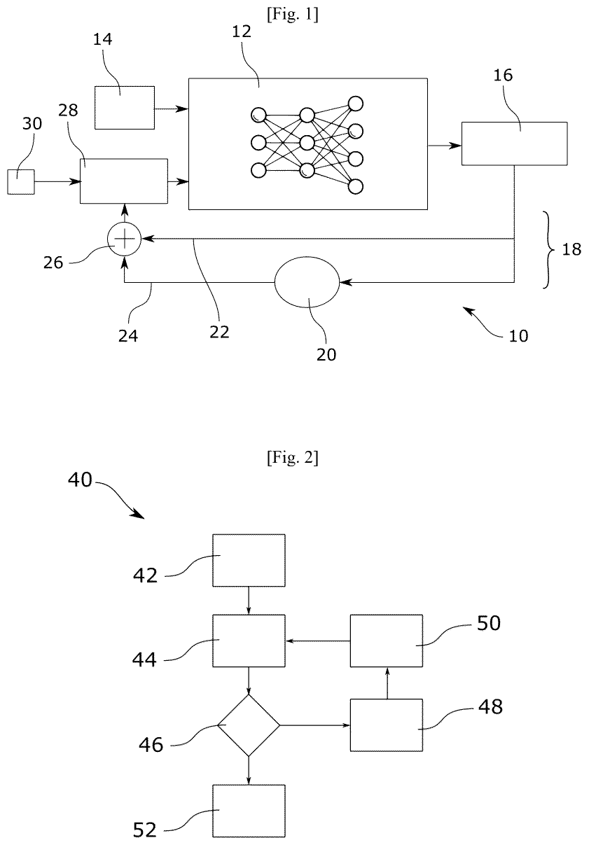

FIG. 1 schematically illustrates a semi-automatic image segmentation system 10 in accordance with one embodiment of the invention.

The segmentation system 10 comprises a neural network 12 configured to receive, at each iteration, input data comprising at least one image 14 to be segmented and to provide output data comprising at least one segmentation mask 16 of each image. The segmentation mask defines, for each part of the image, a label making it possible to identify regions of the image, corresponding to a particular class. The segmentation can be binary but the segmentation can also be a multi-class segmentation and makes it possible to identify more than two classes of regions. At the output of the neural network, a graph cut can make it possible to smooth the output data in order to obtain the segmentation mask.

The segmentation system 10 is integrated around an existing automatic learning model. For example, the system uses an existing encoder-decoder neural network architecture comprising recurrent neural network modules. One embodiment uses for example a ResNet34 encoder described in the publication “He, K., Zhang, X., Ren, S., Sun, J., 2016. Deep residual learning for image recognition. 2016 IEEE Conference on Computer Vision and Pattern Recognition (CVPR), 770-778.” and a decoder equipped with a pair of standard convolutional layers and a recurrent long short-term memory (LSTM) layer corresponding to each step of the oversampling path.

In order to counter the imbalance in the data set, the system uses the focal loss as described in “Lin, T. Y., Goyal, P., Girshick, R. B., He, K., Dollar, P., 2017. Focal loss for dense object detection. 2017 IEEE International Conference on Computer Vision (ICCV), 2999-3007.” and weights per class pre-calculated on the scale of the data set.

The neural network is, for example, pre-trained on the ImageNet data set and then refined on a data set dedicated to the desired task. A data set can be, for example, a data set comprising MRI type medical images of the female pelvis, which are segmented manually by means of manual segmentation software such as 3DSlicer and MITK.

An MRI data set of the female pelvis created by the applicant comprises ninety-seven MRI series representing three thousand and sixty-six cuts in total. This MRI data set of the female pelvis is used for the training of the neural network by way of:
seventy-seven MRI series representing two thousand four hundred and forty-nine cuts for the training set,
ten MRI series representing three hundred and eight cuts for the validation set, and
ten MRI series representing three hundred and nine cuts for the test set.

The cuts of the MRI data set of the female pelvis can be pre-processed via normalization, standardization and bias correction, and a random increase in the data can be anticipated, for example: vertical and horizontal turnover, intensity offsetting for the luminosity, gamma correction for the contrast, as well as blurring and soft filter for adjusting sharpness, etc.

Within MRI type medical images for a gynecological application, examples of labels can be the uterus, the bladder, a possible tumor, a cavity, the background, etc. forming segmentation classes.

The image segmentation system 10 differs from the prior art in that it further comprises a user interaction loop 18 comprising a user interaction module 20 configured to provide at least one user mask representative of an interaction of a real user and/or of a simulated user on each segmentation mask.

The user interaction loop 18 is configured to provide, as input data of the neural network:
each segmentation mask 16 provided by said neural network coming from a previous iteration of the neural network 12, referred to as past segmentation mask, as shown by the arrow 22,
the user mask associated with each past segmentation mask 16 obtained by the user interaction module 20, as shown by the arrow 24.

The segmentation mask 16 and the user mask are associated via a state module 26 to form a state 28 formed from the uniting of the segmentation mask and of the user mask in order to form new input data. During the first iteration, the state 28 is supplied by an equivalent empty structure 30, a mask obtained by an automatically obtained pre-segmentation or a mask derived from the ground truth when the system is being trained. The state 28 thus unites all the past segmentation masks and user masks, thus forming an internal sequential memory for the segmentation system.

The user interaction loop 18 is external to the neural network and does not depend on a specific neural network architecture, although examples of neural networks able to be used are described above.

A conventional interaction loop of the prior art without a memory takes into account the user interactions by providing to the neural network as an input the image to be segmented and the user interactions. The user interactions are represented by virtue of N binary masks with N being the number of segmentation classes. The input of the neural network is thus concatenated in a tensor of size H×L×C, with H being the height of the image, L being the width of the image and C_{base} being the number of channels, which is equal to 1+N in an interaction loop without a memory, corresponding to a channel for the image and N channels for the N segmentation classes.

Prior art solutions have proposed the addition of an internal memory characterized by a group of N binary masks for each segmentation class in which the user interactions are accumulated. The input tensor thus comprises C_{CIM}=1+N channels since the group of user interactions have merged. This type of method can be referred to as “cumulative interaction memory” in light of its operating principle and is implemented according to different variants in particular in the following publications:
Amrehn, M., Gaube, S., Unberath, M., Schebesch, F., Horz, T., Strumia, M., Steidl, S., Kowarschik, M., Maier, A., 2017. UI-Net: Interactive Artificial Neural 1 Networks for Iterative Image Segmentation Based on a User Model, in: Eurographics Workshop on Visual Computing for Biology and Medicine, The Eurographics Association;
Zhou, B., Chen, L., Wang, Z., 2019. Interactive deep editing framework for medical image segmentation, in: Shen, D., Liu, T., Peters, T. M., Staib, L. H., Essert, C., Zhou, S., Yap, P. T., Khan, A. (Eds.), Medical Image Computing and Computer Assisted Intervention-MICCAI 2019, Springer International Publishing, Cham. pp. 329-337;
Liao, X., Li, W., Xu, Q., Wang, X., Jin, B., Zhang, X., Zhang, Y., Wang, Y., 2020. Iteratively-refined interactive 3d medical image segmentation with multi-agent reinforcement learning. 2020 IEEE/CVF Conference on Computer Vision and Pattern Recognition (CVPR), 9391-9399.

The image segmentation system 10 in accordance with the invention thus comprises, by virtue of the preservation of the state of the previous interactions, a sequentiality stored in an input tensor comprising C_{SIM}=1 +2DN channels, with D being the stored state number, i.e. the number of interactions implemented. The factor 2 corresponds to the presence of N interaction masks and of N probability maps corresponding to the results of intermediate segmentation.

The internal sequential memory is thus formed by a FIFO type stack where the successive states corresponding to the interactions are recorded. This memory is external to the neural network and has no interaction with the internal memory of the neural network, in particular with the weights allocated to each node of the neural network which are specific to this neural network and to the type of data.

FIG. 2 schematically illustrates a semi-automatic image segmentation method 40 in accordance with one embodiment of the invention.

The segmentation method comprises a step 42 of receiving the images to be segmented in order to provide them to the neural network as described in the segmentation system.

The method comprises, at each iteration, a step 44 of processing input data comprising each image to be segmented by the neural network in order to provide output data comprising at least one segmentation mask of each image.

If the quality of the segmentation is considered to be correct at a quality control step 46, the segmentation method is terminated and a final step 52 provides the segmentation mask associated with the last segmentation.

If the quality of the segmentation is not correct, each following iteration further comprises a step 48 of receiving a user mask representative of an interaction of a real user on each segmentation mask, and a step 50 of transmission, as input data of the neural network at the following iteration, of each segmentation mask provided by said neural network, and of the user mask.

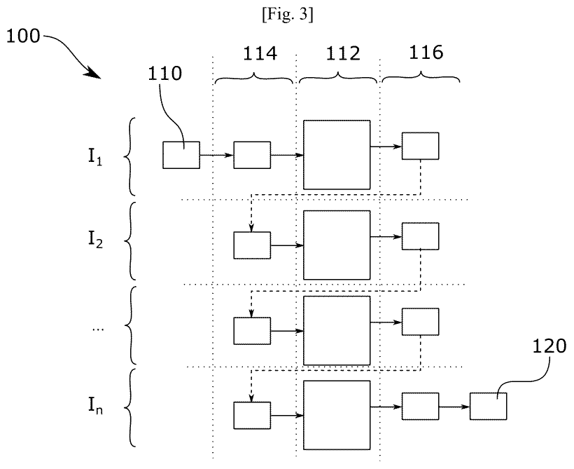

FIG. 3 schematically illustrates steps of a method of training a semi-automatic image segmentation system in accordance with one embodiment of the invention.

The training method 100 comprises, for each image of a data set, a predetermined number of iterations, each iteration being marked from I₁ to Iₙ.

Each iteration comprises a step 112 of processing input data 114 by the neural network in order to provide output data 116. In the first iteration I₁, the input data comprise at least an image to be segmented and a predefined initialization mask 110. The predefined initialization mask 110 is in this case, for example, an empty mask, a trivial mask, a mask obtained by automatic pre-segmentation or a mask derived from the ground truth.

In the following iterations, from I₂ to Iₙ, the input data comprise each image to be segmented, each past segmentation mask obtained at the previous iteration, and a user mask representative of an interaction of a real user and/or of a simulated user, as symbolized by the dotted arrows which link the output data 116 of an iteration to the input data 114 of the following iteration.

The user mask is, for example, obtained by comparison of the segmentation mask with the ground truth, i.e. previously labeled images, making possible supervised learning. The user mask thus simulates the interaction of a user who knows the desired result of the segmentation.

The user mask is, for example, a binary mask by segmentation class, symbolizing a user click in the foreground. The position of the click is chosen randomly in the largest region of the class, following a probability map in which the maximum is at the center of the region, decreasing in moving away from the center and greatly reduced outside the region.

Using the internal sequential memory as described above, the training thus makes it possible to fill the D states memory with realistic values produced by a virtual user. The D states are formed by D iterations in order to fill the internal sequential memory before the weights are updated. The states are preferably formed by inference via the neural network, i.e. without updating the weights of the neural network.

The method also comprises, after each iteration or when the predetermined number of iterations have been effected by the neural network, a step 120 of updating the weights of the neural network from the output data. In this case, in the embodiment illustrated in FIG. 3, the step 120 of updating the weights of the neural network is carried out at the last iteration, based on the last output data 116. The predetermined interaction number is determined independently for each class and for each image set. The maximum interaction number is typically three interactions in order to simulate a conventional user, the minimum being zero.

The probability of adding a supplementary interaction decreases linearly after each interaction to reach zero when the maximum interaction number is reached.

In one embodiment of the invention, a class is selected randomly in each epoch of the training method with a data set for which no user interaction is generated.

In one embodiment of the invention, a percentage of the interactions generated is retained, typically 20%.

1. A semi-automatic image segmentation system comprising:
a neural network configured to receive, at each iteration, input data comprising at least one image to be segmented and to provide output data comprising at least one segmentation mask of each image, and
a user interaction loop comprising a user interaction module configured to provide at least one user mask representative of an interaction of a real user and/or of a simulated user on each segmentation mask, said user interaction loop being configured to provide as input data of the neural network, wherein
each segmentation mask provided by said neural network is coming from a previous iteration of the neural network, referred to as past segmentation mask, and
the user mask is associated with each past segmentation mask.

2. The segmentation system as claimed in claim 1, wherein each user mask representative of a simulated user comprises a simulation of at least one interaction effected by the simulated operator on the segmentation mask associated with the user mask, the position of said interaction in the image being determined according to the difference between said output segmentation mask and ground truth.

3. The segmentation system as claimed in claim 1, further comprising a graph cut module configured to apply a graph cut to the output data of the neural network in order to obtain each segmentation mask.

4. The segmentation system as in claim 1, wherein the user interaction loop comprises an internal sequential memory in which each past segmentation mask and each user mask obtained at each iteration are stored sequentially.

5. A method of training an image segmentation system using at least one data set comprising images to be segmented, the system comprising a neural network configured to receive, at each iteration, input data comprising at least one image to be segmented and to provide output data comprising at least one segmentation mask of each image, and
a user interaction loop comprising a user interaction module configured to provide at least one user mask representative of an interaction of a real user and/or of a simulated user on each segmentation mask, said user interaction loop being configured to provide as input data of the neural network, wherein
each segmentation mask provided by said neural network is coming from a previous iteration of the neural network, referred to as past segmentation mask, and
the user mask is associated with each past segmentation mask, wherein it the method comprises for each image of the data set:
at least two iterations (I1, I2, In) in which the neural network processes the input data in order to provide output data, a first iteration in which the input data comprise at least one image to be segmented and a predefined initialization mask, and subsequent iterations in which the input data comprise each image to be segmented, each past segmentation mask obtained at the previous iteration, and a user mask representative of an interaction of a real user and/or of a simulated user,
a step of updating the weights of the neural network from the output data after each iteration or when a predetermined number of iterations have been effected by the neural network.

6. The training method as claimed in claim 5, wherein the predetermined number of iterations is determined for each image to be segmented and for each data set independently of the predetermined number of iterations determined for the other images to be segmented and the other data sets.

7. A semi-automatic image segmentation method comprising, at each iteration, a step of processing input data comprising each image to be segmented by a neural network in order to provide output data comprising at least one segmentation mask of each image, wherein each iteration further comprises:
a step of receiving a user mask representative of an interaction of a real user on each segmentation mask,
a step of transmitting, as input data of the neural network at the following iteration, each segmentation mask provided by said neural network, and the user mask.

8.-9. canceled
